(19) United States
(12) Patent Application Publication
(10) Pub. No.: US 2018/0183612 A1
(43) Pub. Date: Jun. 28, 2018

(54) AUTHENTICATION TARGET APPARATUS, COMMUNICATION SYSTEM, COMMUNICATION METHOD, AND PROGRAM

(71) Applicant: HONDA MOTOR CO., LTD., Tokyo (JP)

(72) Inventor: Yu Yoshii, Haga-gun (JP)

(21) Appl. No.: 15/844,813

(22) Filed: Dec. 18, 2017

(30) Foreign Application Priority Data
Dec. 27, 2016 (JP) 2016-253317

(51) Int. Cl. H04L 9/32; H04L 29/06

(52) U.S. Cl. CPC H04L 9/3271; H04L 63/108; H04L 63/12; H04L 63/08

(57) ABSTRACT

An authentication target apparatus is an authentication target apparatus that obtains authentication from an authentication apparatus on the basis of a response code generated on the basis of a received challenge code and includes a control unit configured to perform a limiting process limiting the authentication performed with the authentication apparatus when a number of times the authentication is performed with the authentication apparatus exceeds a predetermined number of times within a predetermined period beginning with a period after transmission of a response code.

### CROSS-REFERENCE TO RELATED APPLICATION

Priority is claimed on Japanese Patent Application No. 2016-253317, filed. Dec. 27, 2016, the content of which is incorporated herein by reference.

### BACKGROUND OF THE INVENTION

### Field of the Invention

The present invention relates to an authentication target apparatus, a communication system, a communication method, and a program.

### Description of Related Art

Conventionally, communication systems performing authentication of communication apparatuses are known. Among such communication systems, there are communication systems that perform an authentication process using a challenge code and a response code generated on the basis of the challenge code. For example, a first communication apparatus (authentication target apparatus) transmits a request signal to a second communication apparatus (authentication apparatus). The second communication apparatus transmits a challenge code on the basis of the request signal. The first communication apparatus generates a response code on the basis of the challenge code and transmits the response code to the second communication apparatus. The second communication apparatus performs an authentication process for the first communication apparatus (authentication target apparatus) that has transmitted the request signal described above on the basis of the challenge code and the response code generated on the basis of the challenge code.

In a network through which the first communication apparatus and the second communication apparatus communicate with each other, a disguised communication apparatus different from both the first communication apparatus and the second communication apparatus is assumed to perform a behavior of disguising itself as the second communication apparatus, causing a request signal to be transmitted from the first communication apparatus, transmitting a challenge code in accordance with the request signal, and acquiring a response code for the challenge code (for example, see Japanese Unexamined Patent Application, First Publication No. 2015-063875)

### SUMMARY OF THE INVENTION

However, when the disguised communication apparatus repeatedly performs the process described above, the regularity of response codes for challenge codes can be decoded. When the disguised communication apparatus as described above is present, the reliability of authentication may be degraded.

An aspect relating to the present invention is in consideration of such situations, and one object is to provide an authentication target apparatus, a communication system, a communication method, and a program capable of improving the reliability of authentication using communication.

In order to solve the problems described above, the present invention employs the following aspects.

(1) An authentication target apparatus according to one aspect of the present invention is an authentication target apparatus that obtains authentication from an authentication apparatus on the basis of a response code generated on the basis of a received challenge code and includes a control unit configured to perform a limiting process limiting the authentication performed with the authentication apparatus when a number of times the authentication is performed with the authentication apparatus exceeds a predetermined number of times within a predetermined period beginning with a period after transmission of a response code.

(2) In the aspect (1) described above, the control unit may be configured to perform the limiting process when a number of times a request signal requesting the authentication apparatus to transmit the challenge code is transmitted exceeds the predetermined number of times within the predetermined period.

(3) In the aspect (1) described above, the control unit may be configured to perform the limiting process when a number of times the challenge code is received exceeds the predetermined number of times within the predetermined period.

(4) In the aspect (1) described above, the control unit may be configured to perform the limiting process when a number of times the response code is transmitted exceeds the predetermined number of times within the predetermined period.

(5) In the aspect (1) described above, the control unit may be configured to perform the limiting process when a number of times an authentication process restart event occurs exceeds the predetermined number of times within the predetermined period.

(6)In the aspect (5) described above, the control unit may set reception of a signal indicating reception of a signal from art unauthenticated apparatus from the authentication apparatus as the authentication process restart event.

(7) In the aspect (5) described above, the control unit may set no reception of a signal from the authentication apparatus over a predetermined period as the authentication process restart event.

(8) In the aspect (5) described above, the control unit may set reception of signal representing blocking of communication with the authentication apparatus from the authentication apparatus as the authentication process restart event.

(9) In any one of the aspects (1) to (8) described above, the control unit may be configured to perform a predetermined fail-safe process together with the limiting process.

(10) In any one of the aspects (1) to (9) described above, the predetermined period may begin with a period after completion of the authentication performed with the authentication apparatus.

(11) In any one of the aspects (1) to (described above, the limiting process may be a process of blocking communication with the authentication apparatus.

(12) In any one of the aspects (5) to (8) described above, the limiting process may be a process of not performing the authentication even when the authentication process restart event occurs.

(13 In any one of the aspects (5) to (8) described above, the limiting process may be a process of not transmitting a request code requesting the challenge code even when the authentication process restart event occurs.

(14) In any one of the aspects (1) to (13) described above, the limiting process may be a process of not transmitting the response code even when the challenge code is received from the authentication apparatus.

(15) In any one of the aspects (1) to (13) described above, the limiting process may be a process of transmitting a code different from the response code corresponding to the challenge code received from the authentication apparatus as the response code.

(16) A communication system according to one aspect of the present invention includes: the authentication target apparatus according to any one of the aspects (1) to (15); and an authentication apparatus configured to authenticate the authentication target apparatus.

(17) A communication method according to one aspect of the present invention is a communication method for obtaining authentication from an authentication apparatus on the basis of a response code generated on the basis of a received challenge code and includes limiting the authentication performed with the authentication apparatus when a number of times the authentication is performed with the authentication apparatus exceeds a predetermined number of times within a predetermined period beginning with a period after transmission of the response code.

(18) A program according to one aspect of the present invention causes a computer an authentication target apparatus obtaining authentication from an authentication apparatus on the basis of a response code generated on the basis of a received challenge code to execute: limiting the authentication performed with the authentication apparatus when a number of times the authentication is performed with the authentication apparatus exceeds a predetermined number of times within a predetermined period beginning with a period after transmission of the response code.

According to the aspects of the present invention, there is provided an authentication target apparatus that obtains authentication from an authentication apparatus on the basis of a response code generated on the basis of a received challenge code, and an authentication target apparatus including a control unit, a communication system, a communication method, and a program can be provided which perform a limiting process of limiting the authentication performed with the authentication apparatus when the number of times authentication is performed with the authentication apparatus exceeds a predetermined number of times within a predetermined period beginning with a period after transmission of a response code.

### BRIEF DESCRIPTION OF THE DRAWINGS

FIG. 1 is a diagram illustrating the configuration of a communication system I according to a first embodiment.

FIG. 2A is a diagram illustrating the hardware configuration of an ECU 10 according to this embodiment.

FIG. 2B is a diagram illustrating the functional configuration of the ECU 10 according to this embodiment.

FIG. 3A is a diagram illustrating the hardware configuration of an external apparatus 50 according to this embodiment.

FIG. 3B is a diagram illustrating the functional configuration of the external apparatus 50 according to this embodiment.

FIG. 4 is a diagram illustrating a typical communication protocol according to this embodiment.

FIG. 5 is a state transition diagram illustrating an overview of an authentication request process of an external apparatus 50 of a comparative example.

FIG. 6 is a diagram illustrating the sequence of an interruption performed by an ECU 20 according to this embodiment.

FIG. 7 is a flowchart of an authentication process for starting communication according to this embodiment.

FIG. 8 is a flowchart of an authentication process for starting communication according to this embodiment,

### DETAILED DESCRIPTION OF THE INVENTION

Hereinafter, an authentication target apparatus, a communication system, a communication method, and a program according to embodiments of the present invention will be described with reference to the drawings.

### First Embodiment

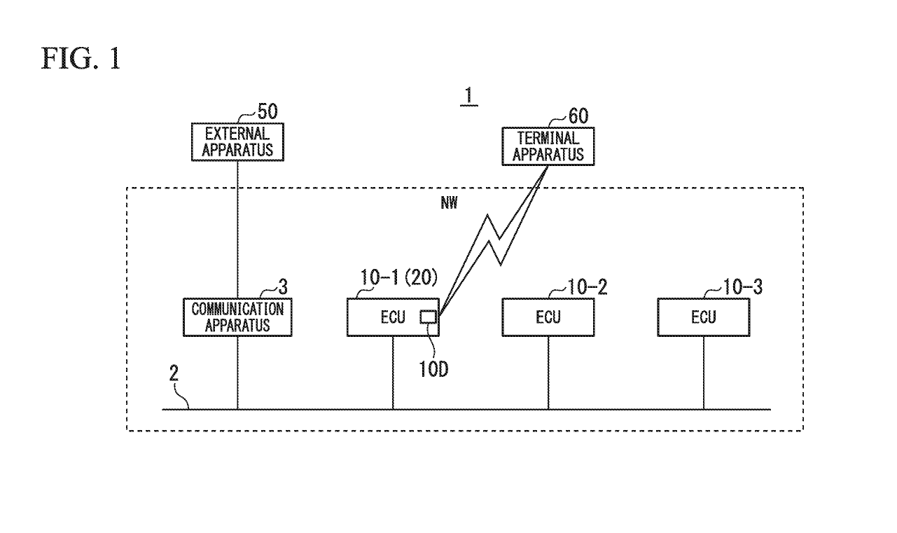

FIG. 1 is a diagram illustrating the configuration of a communication system 1 according to this embodiment. The communication system 1, for example, is mounted in a vehicle. The communication system 1 configures a network NW at least inside the vehicle. In the network NW, for example, communication on the basis of a communication system such as a controller area network (CAN) protocol or IEEE 802.3is performed through a bus 2.

The communication system includes ECUs 10-1 to 10-3 connected to the bus 2.

Hereinafter, when the ECUs 10-1 to 10-3 do not need to be discriminated from each other, each will simply be referred to as an ECU 10. Although devices such as the ECUs 10-1 to 10-3 are described as being connected to the common bus 2, the devices may be connected to other buses connected to be communicable with each other through a relay device not illustrated in the drawing or the like.

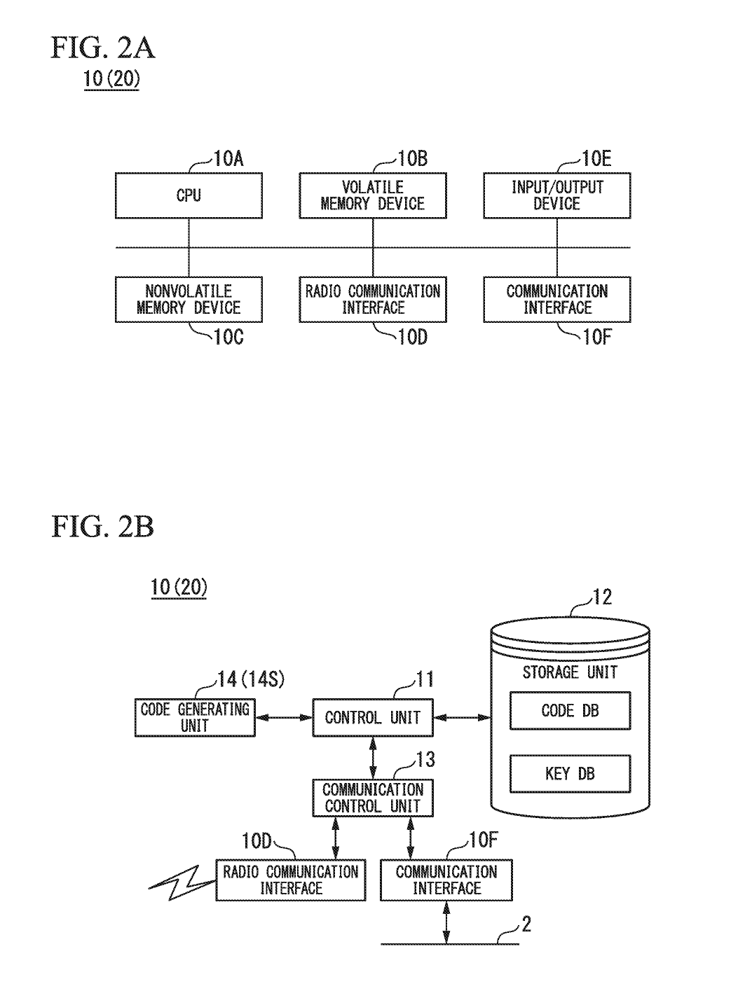

The ECU 10, for example, is an engine ECU controlling an engine, a safety belt ECU controlling a safety belt, or the like. The ECU 10 receives a frame transmitted to the network NW to which the ECU 10 belongs. Hereinafter, each frame transmitted to the network NW will be referred to as a frame F. The frame F is identified using an identifier (hereinafter referred to as an ID) attached thereto. The ECU 10 stores an ID (hereinafter referred to as a registration ID) used for identifying a frame F relating to the ECU 10 in a storage unit 12 (FIG. 2B). When a frame F is received, by referring to an ID (hereinafter referred to as a reception ID) attached to the received frame F, the ECU 10 extracts and acquires a frame F to which the reception ID having the same value as the registration ID is attached. The ECU 10 performs an authentication process of a communication partner at the time of performing communication.

In the network NW, a communication apparatus 3 is disposed in which a terminal DLC that is a terminal used for a connection with an external apparatus 50 such as a verification apparatus is arranged. A verification apparatus or the like connected to the communication apparatus 3 at the time of performing maintenance of a vehicle or the like is an example of the external apparatus 50. The verification apparatus tests and verifies the state of the communication system 1 by communicating with the ECU 10 connected to the bus 2. Except at the time of maintenance of a vehicle or the like, the communication system 1 can function without connecting a verification apparatus or the like to the communication apparatus 3.

In the description below, an ECU 20, for example, is contaminated by a malicious program and disguises itself as an ECU 10 performing a justifiable authentication process. For example, the ECU 20 has a hardware configuration similar to that of the ECU 10. For example, the ECU 20 is an ECU 10-1 executing a malicious program.

FIG. 2A is a diagram illustrating the hardware configuration of an ECU 10 (ECU 20) according to this embodiment. The ECU 10 is a computer including: a CPU 10A; a volatile memory device 10B such as a random access memory (RAM) or a register; a nonvolatile memory device 10C such as a read-only memory (ROM), an electrically erasable and programmable read-only memory (EEPROM), or a hard disk drive (HDD); a radio communication interface 10D; an input/output device 10E; a communication interface 10F; and the like. There are cases in which the ECU 10 does not include one or either of the radio communication interface 10D and the input/output device 10E in accordance with the type, the use, or the like.

FIG. 2B is a diagram illustrating the functional configuration of the ECU 10 (ECU 20) according to this embodiment. The ECU 10 includes: a control unit 11; a. storage unit 12; a communication control unit 13; and a code generating unit 14.

For example, the control unit 11, the communication control unit 13, and the code generating unit 14 are realized by a processor such as the CPU 10A executing a program.

The control unit 11 controls units including the communication control nit 13 and the code generating unit 14. For example, the control unit 11 receives a. communication request from the external apparatus 50 or the like and performs an authentication process of the external apparatus 50 or the like in accordance with the communication request from the external apparatus 50 or the like. Hereinafter, description will focus on the authentication process performed by the control unit 11.

The storage unit 12 is realized by the volatile memory device 1013 and the nonvolatile memory device 10C. The storage unit 12 stores programs such as an application program and a communication control program and various kinds of information referred to in accordance with the execution of the programs. The various kinds of information described above include a challenge code (hereinafter, referred to as a seed) that is generated by the code generating unit 14 and has a determined value, a response code (hereinafter, referred to as a KEY1) on the basis of the seed described above, and the like. The seed is added to a code DB and is stored in the storage unit 12 as the code DB. The KEY1 is stored in the storage unit 12 as a key DB that can be referred to by using the value of the seed as a key.

The communication control unit 13 controls communication with an external apparatus through the communication interface 10F. The communication interface 10F is an interface used for connecting the ECU 10 to the bus 2.

The communication control unit 13 controls the communication interface 10F, whereby communication with another apparatus requested by the control unit 11 is enabled. The communication control unit 13 receives a notification from the comma communication interface 10F and notifies the control unit 11 of a communication request from another apparatus. According to the authentication process or the like performed by the control unit 11, acceptance/non-acceptance of a communication request from another apparatus is determined.

The code generating unit 14 sets a seed on the basis of a predetermined rule or a random number in accordance with a request for an authentication process from the external apparatus 50 or the like.

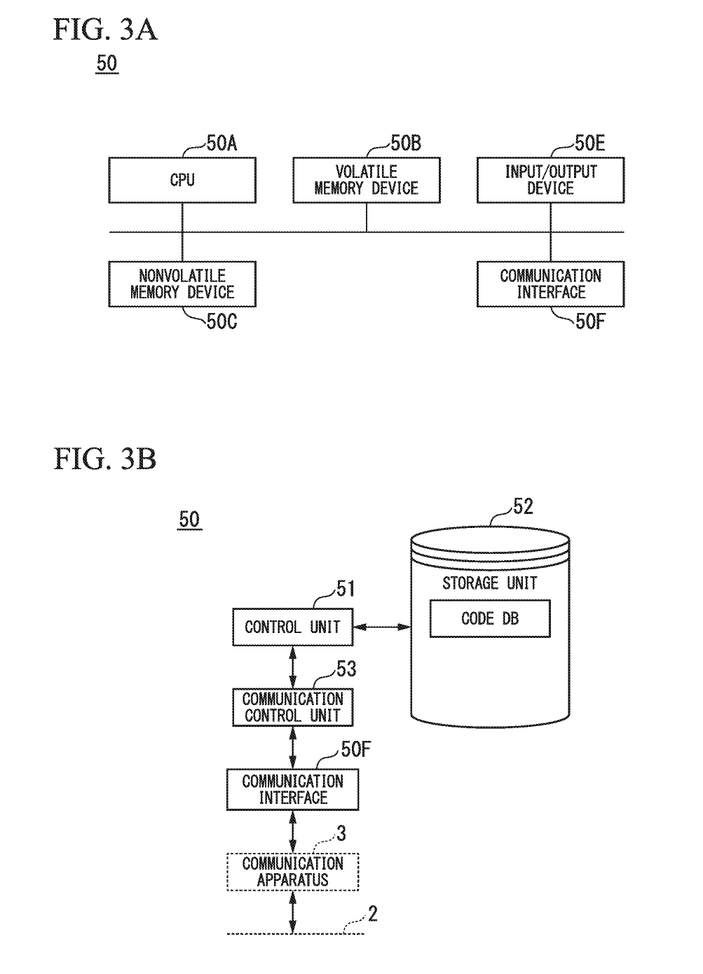

FIG. 3A is a diagram illustrating the hardware configuration of an external apparatus 50 according to this embodiment. The external apparatus 50 is a computer including: a CPU 50A; a volatile memory device 50B such as a RAM or a register; a nonvolatile memory device 50C such as a ROM, an EEPROM, or an HDD; an input/output device 50E; a communication interface 50F; and the like.

FIG. 3B is a diagram illustrating the functional configuration of the external apparatus 50 according to this embodiment. The external apparatus 50 includes a control unit 51, a storage unit 52, and a communication control unit 53. For example, the control unit 51 and the communication control unit 53 are realized by a processor such as the CPU 50A executing a program.

The control unit 51 controls units including the communication control unit 53. For example, the control unit 51 transmits a communication request to the ECU 10 or the like and causes the ECU 10 or the like to perform an authentication process in accordance with a response from the ECU 10 or the like. The control unit 51 detects a status of communication with the ECU 10 or the like and outputs a result thereof to the input/output device 50E. The status of communication described above includes a result of authentication performed by the ECU 10 or the like, a result of detection of legitimacy of the ECU 10 or the like, and the like.

Hereinafter, description will focus on the process relating an authentication process performed by the control unit 51. The process relating to the authentication process includes an authentication request for the ECU 10 or the like and processes such as a process regulating communication with an apparatus performing an illegitimate process and the like. As an authentication request fir the ECU 10 or the like, the control unit 51 transmits an authentication request for the ECU 10 or the like, generates a response code (hereinafter referred to as a KEY2) on the basis of a seed received from the ECU 10 or the like, and transmits the KEY2 to the ECU 10 or the like. As the process regulating communication with an apparatus performing an illegitimate communication process or the like, the control unit 51 detects an illegitimate communication process and blocks the communication, thereby leading the external apparatus 50 to a safe state. Details thereof will be described later.

The storage unit 52 is realized by the volatile memory device 50B and the nonvolatile memory device 50C. The storage unit 52 stores programs such as an application program and a communication control program and various kinds of information referred to in accordance with the execution of the programs. Various kinds of information described above include a seed received by the control unit 51 from the ECU 10 or the like and the like. The seed is added to a code DB and is stored in the storage unit 52 as the code DB.

The communication of unit 53 controls communication with an external apparatus through the communication interface 50F. The communication interlace 50F is an interface connecting the external apparatus 50 to the bus 2 through the communication apparatus 3. The communication control unit 53 enables communication with another apparatus requested by the control unit 51 by controlling the communication interface 50F. The communication control unit 53 receives a notification from the communication interface 50F and gives a notification of a signal such as a seed from the ECU 10 or the like to the control unit 51.

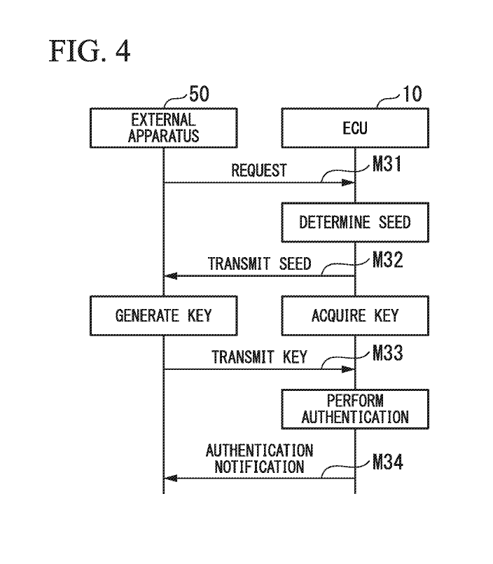

FIG. 4 is a diagram illustrating a typical communication protocol according to this embodiment. The ECU 10 limits the communication partner by performing the authentication process of the communication partner. The communication protocol illustrated in the drawing illustrates a typical example relating to the authentication process of the communication partner.

For example, the external apparatus 50 (the authentication target apparatus) transmits a seed request (request signal). The ECU 10 receives the seed request (M31).

The ECU 10 (control unit 11) generates a seed on the basis of the received seed request by using the code generating unit 14 and transmits the generated seed (M32). The ECU 10 (control unit 11) acquires a KEY1 corresponding to the seed from the key DB of the storage unit 12. Instead of the process described above, the control unit 11 may calculate the KEY1 on the basis of a predetermined arithmetic operation equation.

The external apparatus 50 receives a seed and generates and transmits a response code (hereinafter referred to as a KEY2) on the basis of the seed. The ECU 10 (control unit 11) receives the KEY2 transmitted by the external apparatus 50 (M33).

The ECU 10 (control unit 11) performs an authentication process on the basis of the KEY1 corresponding to the seed and the received KEY2 and gives a notification of a result thereof (M34). More specifically, when the KEY1 and the KEY2 represent the same code, the ECU 10 (control unit 11) determines that the external apparatus 50 (authentication target apparatus) is a legitimate apparatus and gives a notification that it has obtained authentication that the external apparatus 50 (the authentication target apparatus) is a legitimate apparatus.

A typical example of the authentication process of the communication partner has been described above. In the description below, when the KEY1 and the KEY2 are to be collectively represented without being discriminated from each other, each thereof may simply be referred to as a KEY.

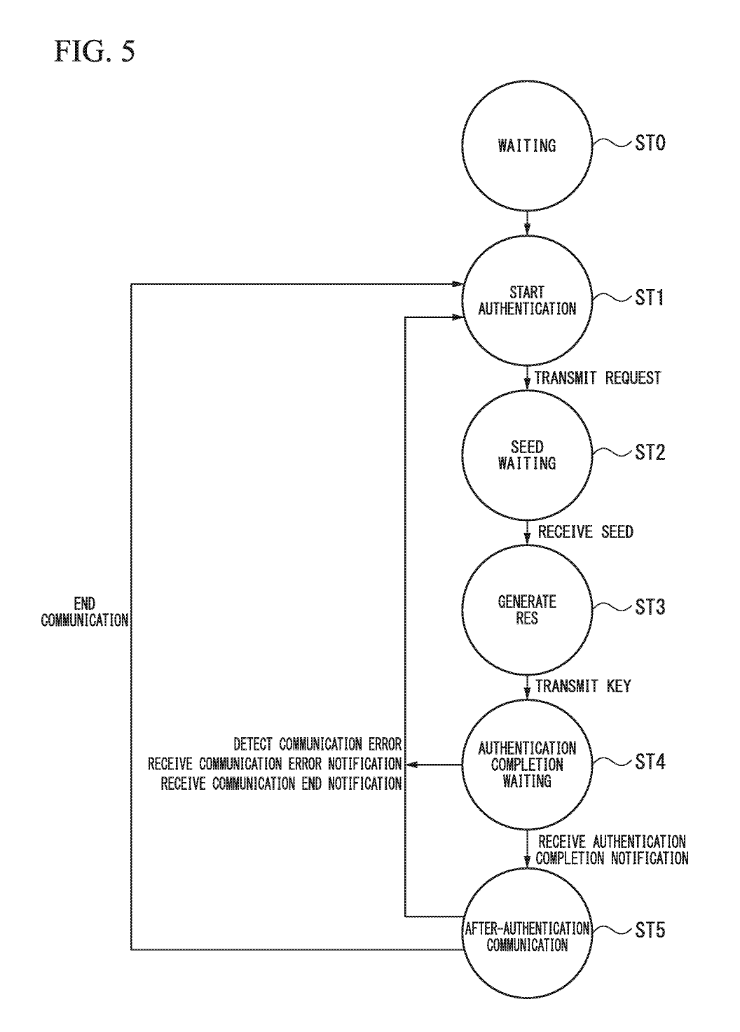

FIG. 5 is a state transition diagram illustrating an overview of an authentication request process of an external apparatus 50 of a comparative example. In the authentication request process illustrated in the drawing, a process corresponding to an ate communication process and the like are not included.

In a waiting state (ST0) before the start of authentication, the control unit 51 transitions the control state to a state (ST1: authentication start) starting the authentication in accordance with detection of an operation from a user or the like.

In the authentication start state (ST1), by transmitting (request transmission) a seed request, the control unit 51 transitions the control state to a state (hereinafter referred to as a seed waiting process state) (ST2: seed waiting) in which a process of waiting for a notification of a seed is performed.

In the seed waiting process state (ST2), by receiving a seed, the control unit 51 transitions the control state to a response code generating state (ST3: RES generation). In the response code generating state, the control unit 51 generates a KEY2.

In the response code generating state (ST3: RES generation), by causing the apparatus (the ECU 10 or the like) that has transmitted the seed to perform an authentication process by transmitting (KEY transmission) a KEY2, the control unit 51 transitions the control state to a control state (hereinafter referred to as an authentication completion waiting state) (ST4: authentication completion waiting) in which a notification of the completion of the authentication process is awaited.

By receiving the notification of the completion of the authentication process, the control unit 51 transitions the control state to the communication state (ST5: after-authentication communication) under a situation in which authentication is obtained. In this state, for example, a signal that is transmitted only to an apparatus obtaining authentication is transmitted from the ECU 10 to the external apparatus 50.

In the after-authentication communication state (ST5), as the communication ends, the control unit 51 transitions the control state to the authentication start state (ST1).

In addition, in each of the authentication completion waiting state (ST4) after the transmission of a response code or the after-authentication communication state (ST5), according to detection of a communication error, reception of a notification of a communication error, reception (communication end reception) of a communication end notification, or the like, the control unit 51 transitions the control state to the authentication start state (ST1).

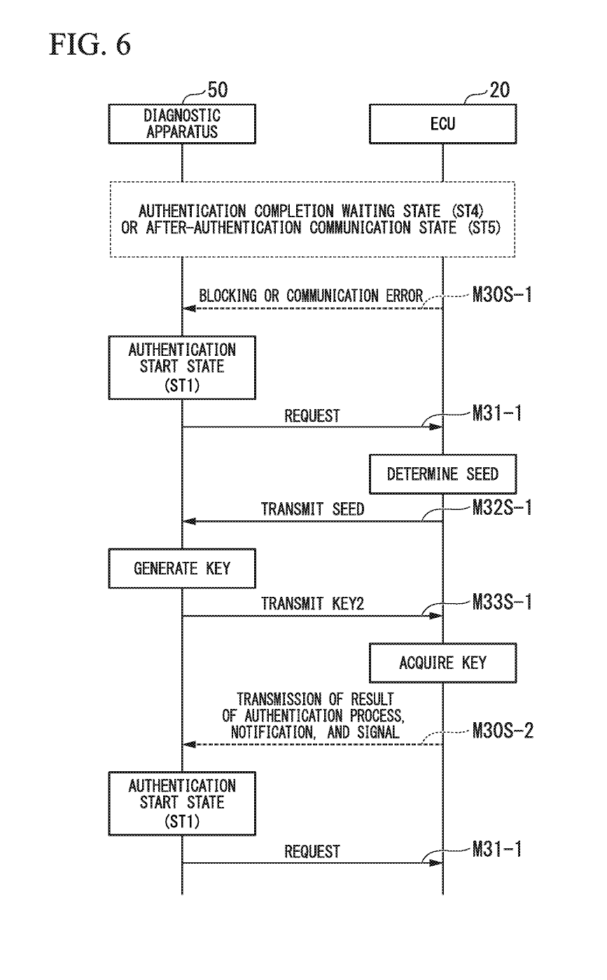

FIG. 6 is a diagram illustrating the sequence of an interruption performed by an ECU 20 according to this embodiment. The sequence illustrated in the drawing illustrates an example of a case in which the external apparatus 50 requests an authentication process for the ECU 20.

For example, when the external apparatus 50 is in the control state of the authentication completion waiting state (ST4) or the after-authentication communication state (ST5) illustrated in FIG. 5 described above, the ECU 20 intentionally ends communication with the external apparatus 50 or generates a communication error. As examples thereof, a case in which the ECU 20 ends the authentication process performed with the external apparatus 50 in the middle of the process after reception of a response code and gives a notification of an indication thereof, a case in which an indication (authentication clearing fail) representing that a received response code is no authenticated to be legitimate is notified of, a case in which, after communication is established under the situation in which authentication can be obtained, a notification for urging to obtain authentication again is given (M30S-1), a case in which the ECU 20 causes the external apparatus 50 to determine a communication error by not giving a notification of a result of authentication on the basis of the response code, and a case in which the external apparatus 50 is caused to determine a communication error by not transmitting a signal to the external apparatus 50 after communication is established under a situation in which authentication can be obtained may be considered.

According to an occurrence of an “authentication process restart event” such as a notification from the ECU 20 of the example described above or a determination of a communication error, the external apparatus 50 is in the authentication start state (ST1) (FIG. 5). Thereafter, in order to establish communication under a situation in which authentication can be acquired, in other words, in order to be in the after-authentication communication state (ST5), the external apparatus 50 (authentication target apparatus) newly transmits a seed request (M31-1). The ECU 20 receives the seed request (M31-1).

The ECU 20 transmits a seed determined according to the received seed request (M32S-1).

The external apparatus 50 receives the seed, generates a response code (hereinafter referred to as a KEY2) on the basis of the seed, and transmits the generated response code. The ECU 20 receives the KEY2 transmitted by the external apparatus 50 (M33S-1).

The ECU 20 acquires the received KEY2 as a KEY corresponding to the seed and stores the KEY2 in the storage unit. The ECU 20 performs the notification described above or a behavior of not transmitting a result of the authentication or a signal (M30S-2).

The external apparatus 50 functions to establish communication again on the basis of reception of the notification from the ECU 20 or an error determination. The external apparatus 50 repeats the transmission of a seed request transmitted in M31-1 in advance (M31-2).

Hereinafter, similar state transitions are repeated by the external apparatus 50 and the ECU 20. As a result, the ECU 20 can acquire a plurality of combinations of KEY2s corresponding to seeds transmitted thereby. In this way, although the ECU 20 cannot directly generate a KEY1, the ECU 20 can generate a KEY1 by conjecturing a relationship on the basis of the plurality of combinations of KEY2s corresponding to the seeds.

The ECU 20 conjectures a relationship between the seed and the KEY by disguising the authentication process by using a method such as the sequence described above. For this, the external apparatus 50 according to this embodiment performs a preferable countermeasure for a disguise of the authentication process performed by the ECU 20. Hereinafter, the process will be described.

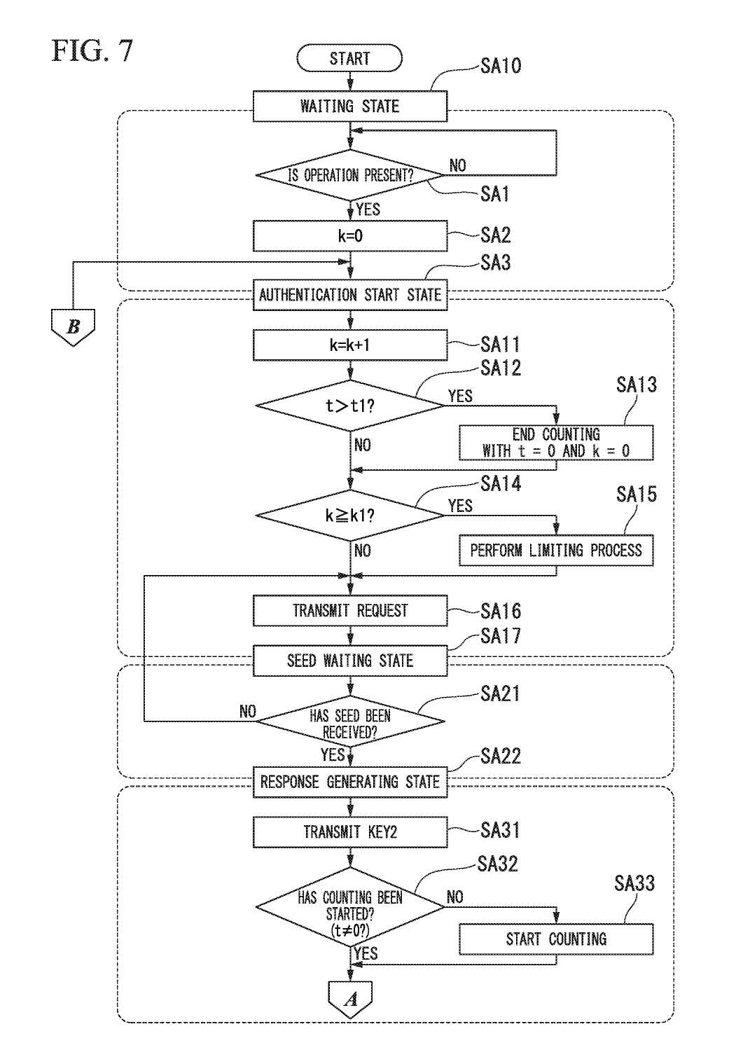

FIG. 7 is a flowchart of an authentication process for starting communication according to this embodiment.

The control unit 51 determines whether there is a trigger such as a user operation for a state transition to the authentication start state starting an authentication process from the waiting state (ST0 (FIG. 5)) (SA1). As a trigger for a state transition, other than a user operation, a known method such as a physical connection of the external apparatus 50 and the ECU 10 (20) through a wire may be used.

In a case where a user operation as the trigger is detected, the control unit 51 initializes the number k of times a predetermined event (authentication process restart event) is detected to “0” (SA2) and transitions the control state to the authentication start state (ST1 (FIG. 5)) (SA3).

Next, the control unit 51 adds “1” to the number k of times a predetermined event is detected (SA11).

Next, the control unit 51 deter nines whether or not an elapsed time t exceeds a predetermined period t1 (SA12). For example, the elapsed time t according to this embodiment is an elapsed period t after the first transmission of a response code. In the description below, it will simply be referred to as an “elapsed time t”. Here, the process of transmitting a response code is a process of a later stage.

Next, in a case where the elapsed time t exceeds the predetermined period t1, the elapsed time t is set to “0”, the counting is ended, and the number k of times a predetermined event is detected is initialized to “0” (SA13).

As a result of the determination of SA12, in a case where the elapsed time t is within the predetermined period t1 or after the process of SA13 ends, the control unit 51 determines whether or not the number k of times a predetermined event is detected is a predetermined number k1 of times or more (SA14).

In a case where the number k of times a predetermined event is detected is the predetermined number k1 of times or more, the control unit 51 sets a limit flag used for performing a limiting process (SA15). By setting the limit flag, the control unit 51 performs the limiting process in a process of a later stage. For example, in a case where the number of times a predetermined event occurs (the occurrence number of times) of a predetermined event, in other words, the number k of times a predetermined event (authentication process restart event) is detected exceeds the predetermined number k1 of times, the control unit 51 may perform the limiting process.

As a result of the determination of SA14, in a case where the number k of times a predetermined event is detected is less than the predetermined number k1 of times or after the process of SA15 is ended, by transmitting a request code (seed request) (SA16), the control unit 51 transitions the control state to a seed waiting state (ST2 (FIG. 5)) (SA17). In addition, in a case where the limit flag is set, the control unit 51 blocks communication with the ECU 10 (20) by the limiting process. For example, the control unit 51 may not perform the following process for authentication described below or may limit the transmission of a request code (seed request).

Next, the control unit 51 determines whether or not a seed has been received (SA21) in the seed waiting state (ST2) and waits until a seed is received.

In a case where a seed has been received, the control unit 51 transitions the control state to a response code generating state (ST3) (SA22).

Next, in the response code generating state (ST3 (FIG. 5)), the control unit 51 transmits a KEY2 that is a response code (SA31). In addition, in a case where the limit flag is set, the control unit 51 may limit the transmission of a response code (KEY2) by the limiting process. Alternatively, in a ease where the limit flag is set, the control unit 51 may transmit a code different from a regular response code (KEY2) as a response code by the limiting process.

Next, the control unit 51 determines whether or not a counting process of the elapsed time t has been started (SA32). In a case where the counting process of the elapsed time t has not been started, the control unit 51 starts the counting process of the elapsed time t (SA33).

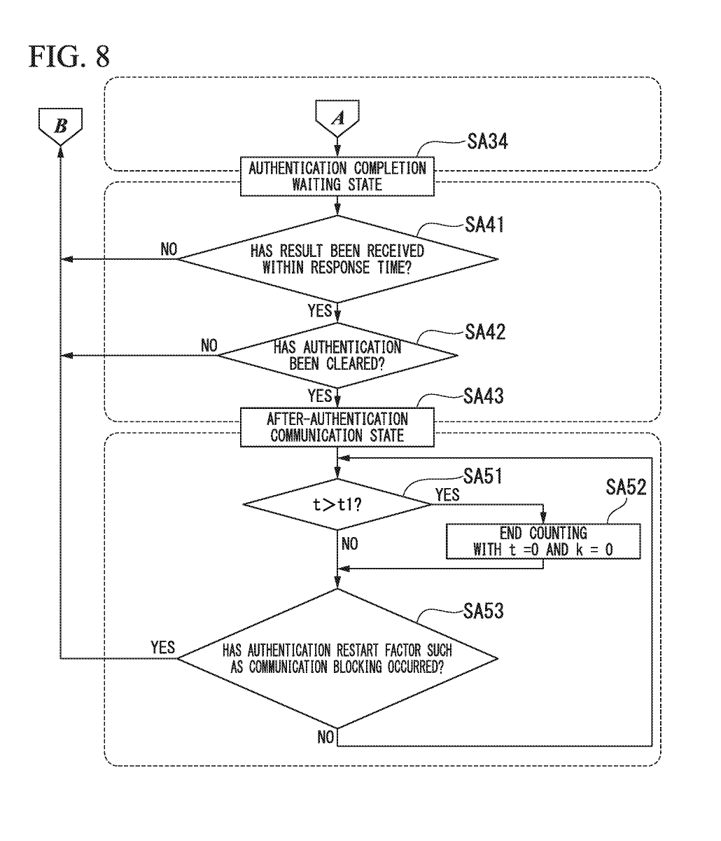

As a result of the determination of SA32, in a case where the counting process of the elapsed time t has been started or after the process of SA33 is ended, as illustrated in FIG. 8, the control unit 51 transitions the control state to an authentication completion waiting state (ST4 (FIG. 5)) (SA34).

Next, in the authentication completion waiting state (ST4), the control unit 51 determines whether or not an authentication completion notification (result) has been received while the elapsed time T after the transition to the authentication completion waiting state is within a predetermined response time T2 (T≤T2) (SA41). In a case where an elapsed time T after the transition to the authentication completion waiting state exceeds a predetermined response time T2 until an authentication completion notification (result) is received, in other words, in a case where an authentication completion notification (result) cannot be received until the time T2 elapses after the transition to the authentication completion waiting state, the control unit 51 detects an occurrence of a predetermined event (authentication process restart event) and causes the process to proceed to SA3.

In a case where an authentication completion notification (result) is received before the elapsed time T after the transition to the authentication completion waiting state exceeds the predetermined response time T2, the control unit 51 determines a result of the authentication process, in other words, whether or not authentication representing a regular apparatus performed by the ECU 20 is obtained (whether or not authentication has been cleared) (SA42). In a case where the authentication has not been cleared, the control unit 51 detects an occurrence of a predetermined event (authentication process restart event) and causes the process to proceed to SA3.

On the other hand, in a case where the authentication has been cleared, the control unit 51 transitions the control state to a communication state (the after-authentication communication state (ST5 (FIG. 5))) under the situation in which the authentication is acquired (SA43).

Next, in the after-authentication communication state (ST5), the control unit 51 determines whether or not the elapsed time t exceeds the predetermined period t1 (SA51).

Next, is a case where the elapsed time t exceeds the predetermined period t1, the elapsed time t is set to “0”, the counting is ended, and the number k of times a predetermined event is detected is initialized to “0” (SA52).

As a result of the determination of SA51, in a case where the elapsed time t is the predetermined period t1 or less or after the process of SA52 is ended, the control unit 51 determines whether or not an authentication restart factor such as communication blocking has occurred (SA53). In a case where the authentication restart factor has not occurred, the control unit 51 repeats the process from SA51.

On the other hand, in a case where the predetermined event described above (authentication process restart event) has occurred, the control unit 51 causes the process to proceed to SA3.

In addition, the control unit 51 may end the series of processes illustrated in the drawing in accordance with the end of a user operation or an end of the process defined in advance.

The external apparatus 50 detects the presence of an apparatus as the ECU 20 performing an illegitimate process by the process described above.

### Limiting Process

The limiting process will be described. As the limiting process is started in SA15 described above, the control unit 51, for example, performs any one of first to fourth limiting processes described below, whereby the execution of the authentication process in the ECU 20 is limited.

The first limiting process is a process (communication blocking process) of the control unit 51 blocking communication with an authentication apparatus of a target of the ECU 20 or the like.

The second limiting process is a process (transmission waiting process) in which, even when the control unit 51 detects an authentication process restart event such as reception of a notification from the ECU 20 or detection of a communication error, authentication is not requested for the ECU 20 of the target or the like, in other words, a request code (see request) not transmitted to the ECU 20 of the target or the like.

The third limiting process is a process(transmission waiting process) in which, even when the control unit 51 receives a challenge code (seed) from an authentication apparatus of a target of the ECU 20 or the like, a response code (KEY2) for the challenge code is not transmitted.

The fourth limiting process is a process (disguised response process) in which the control unit 51 transmits a code different from a KEY2 corresponding to a seed received from the authentication apparatus of the target of the ECU 20 or the like as the KEY2. For example, a code different from the KEY2 corresponding to the seed may be a predetermined code set in advance, a code on the basis of a generated random number, or a KEY2 selected from among KEY2s that have already been transmitted toward the authentication apparatus of the target.

### Condition for Performing Limiting Process

Next, a condition for performing the limiting process according to the embodiment will be described.

The control unit 51 performs the process of limiting authentication performed with the authentication apparatus such as the ECU 20 as described below within the predetermined period t1 from a period after the transmission of a response code. In a case where the number k of times a seed request requesting the authentication apparatus such as the ECU 20 to transmit a seed is transmitted exceeds a predetermined number k1 of times within a predetermined period t1, the control unit 51 may transition the control state to a limiting process state (ST6 (FIG. 5)) to perform the limiting process described above. As a result, there is no transmission of a seed request exceeding the predetermined number k1 of times from the external apparatus 50.

After the transition to the limiting process state, the control unit 51 maintains the state and, for example, blocks the communication with the ECU 20 of the target apparatus. Until an initialization process or the like is performed, the control unit 51 maintains the state and transitions the control state to a waiting state (ST0) by performing the initialization process.

### Process Accompanying Limiting Process

Next, a process accompanying the limiting process will be described.

The control unit 51 may perform a predetermined fail-safe process together with the execution of the limiting process. The predetermined fail-safe process includes a process of displaying an indication representing the execution of the limiting process in the external apparatus 50, a process of notifying another apparatus that the external apparatus 50 performs the limiting process, and the like. By performing the predetermined fail-safe process, the control unit 51 can further improve the reliability of the authentication through communication.

In addition, the control unit 51 sets t1 as the predetermined period beginning with a period after the transmission of a response code. The control unit 51, as in the example described above, may set the predetermined time t1 from the transmission of a response code as a start point or may set the predetermined period t1 from the completion of authentication performed with the authentication apparatus as a start point.

According to the embodiment described above, the external apparatus 50 is an authentication target apparatus obtaining authentication from an authentication apparatus such as the ECU 20 or the like on the basis of a KEY2 generated on the basis of the received seed. In a case where the number of times authentication performed with the authentication apparatus such as the ECU 20 is performed exceeds a predetermined number of times within a predetermined period beginning with a period after the transmission of the KEY2, the control unit 51 of the external apparatus 50 performs limiting process limiting the authentication performed with the authentication apparatus such as the ECU 20. Accordingly, the external apparatus 50 can further improve the reliability of the authentication through communication.

In addition, the authentication process restart event may be defined as below.

For example, the control unit 51 may determine a case where, from the authentication apparatus such as the ECU 20, a signal indicating the reception of a signal from an unauthenticated apparatus in an authentication apparatus or another ECU 10 is received from another ECU 10 as an authentication process restart event.

In addition, for example, the control unit 51 may determine a case where a signal from the authentication apparatus such as the ECU 10 has not been received over the predetermined period as an authentication process restart event.

Furthermore, the control unit 51 may determine a case where a blocking signal representing blocking of communication is received from the authentication apparatus such as the ECU 20 as an authentication process restart event.

As described above, according to this modified example, in addition to the acquisition of effects similar to those of the first embodiment, a condition handled as an authentication process restart event can be set as a determination condition, and accordingly, the degree of freedom in the determination can be improved.

### Modified Example 1 of First Embodiment

A modified example 1 of the first embodiment will be described. In this modified example, instead of performing the process similar to the process of SA11 to SA15 described above for starting the limiting process alter the transition (SA3) to the authentication start state (ST1), the process is performed after the transmission (SA16) of the request code (seed request).

For example, in accordance with the detection (SA1) of a user operation or the like, alter initializing the number k of times a predetermined event is detected to “0” (SA2), the control unit 51 transitions the control state to the authentication start state (ST1 (FIG. 5)) starting an authentication process from the waiting state (ST0 (FIG. 5)) (SA3).

Next, the control unit 51 transmits a request code (SA16). Thereafter, the control unit 51 performs the process of SA11 to SA15. Next, the control unit 51 transitions the control state to a seed waiting state (ST2 (FIG. 5)) (SA17). The process of SA17 and subsequent steps are similar to those of the embodiment described above.

According to this modified example, in addition to the acquisition of effects similar to those of the embodiment, after transmission (SA16) of a request code (seed request), the process for starting the limiting process is performed. Accordingly, the process for starting the limiting process can be performed in a sequence different from that according to the embodiment.

### Modified Example 2 of First Embodiment

A modified example 2 of the first embodiment will be described. In this modified example, the order of the process similar to the process of SA11 to SA15 described above for starting the limiting process is not after the transition (SA3) to the authentication start state (ST1) but after the process of SA31.

For example, the control unit 51, after initializing the number k of times a predetermined event is detected through detection (SA1) of a user operation or the like to “0” (SA2), transitions the control state to the authentication start state (ST1 (FIG. 5)) starting an authentication process from the waiting state (ST0 (FIG. 5)) (SA3).

Next, the control unit 51 transmits a request code (SA16) and transitions the control state to the seed waiting state (ST2 (FIG. 5)) (SA17). Thereafter, the control unit 51, similar to the embodiment, performs the process of SA21 to SA22. Next, the control unit 51 transmits a KEY2 that is s response code (SA31).

Thereafter, the control unit 51 performs the process of SA11 to SA15.

Next, the control unit 51 determines whether or not the counting process of the elapsed time t has been started (SA32). The process of SA32 and subsequent steps are similar to those according to the embodiment described above.

According to this modified example, in addition to the acquisition of effects similar to those of the embodiment, after the process (SA31) of transmitting a response code (KEY2), the process for starting the limiting process is performed.

Accordingly, the process for starting the limiting process can be performed in a sequence different from that according to the embodiment.

### Modified Example 3 of First Embodiment

A modified example 3 of the first embodiment will be described. In this modified example, the order of the process similar to the process of SA11 to SA15 described above for starting the limiting process is performed not after the transition (SA3) to the authentication start state (ST1) but after the process (SA21) of receiving a seed.

For example, the control unit 51, after initializing the number k of times a predetermined event is detected through detection (SA1) of a user operation or the like to “0” (SA2), transitions the control state to the authentication start state (ST1 (FIG. 5)) starting an authentication process from the waiting state (ST0 (FIG. 5)) (SA3).

Next, the control unit 51 transmits a request code (SA16) and transitions the control state to the seed waiting state (ST2 (FIG. 5)) (SA17).

Next, in the seed waiting state (ST2), the control unit 51 determines whether or not a seed has been received (SA21) and waits until a seed is received.

In a case where the control unit 51 receives a seed, the control unit 51 performs the process of SA11 to SA15.

The process of SA22 and subsequent steps are similar to those according to the embodiment described above.

According to this modified example, in addition to the acquisition of effects similar to those of the embodiment, the process for starting the limiting process is performed after the process (SA21) of receiving a seed. Accordingly, the process for starting the limiting process can be performed in a sequence different from that according to the embodiment.

### Modified Example 4 of First Embodiment

A modified example 4 of the first embodiment will be described. In this modified example, the trigger for starting counting in SA33 described above is not the transmission (SA31) of a response signal but a transition (SA43) to the after-authentication communication state (ST5). In other words, in the first embodiment, while the period t beginning with the period after the transmission of a response code is set as the elapsed time t after the first transmission of a response code, in this modified example, for example, the period t beginning with the period after the transmission of a response code is set as an elapsed time t after the transition to the after-authentication communication state (ST5). According to such a modified example, like when acceptance/rejection of authentication is determined, and a situation in which communication is started under a situation in which authentication is obtained is made up, even in a case where the ECU 20 or the like disguises itself as a further legitimate authentication apparatus, such a case can be appropriately handled.

For example, in the response code generating state (ST3 (FIG. 5)), the control unit 51 transmits (SA31) a KEY2 that is a response code and transitions the control state to the authentication completion waiting state (ST4 (FIG. 5)) (SA34).

Next, in a case where the control unit 51 determines that the authentication has been cleared in SA42 through the process of SA41 to SA42 in the authentication completion waiting state (ST4), the control unit 51 transitions the control state to a communication state (the after-authentication communication state (ST5 (FIG. 5))) under a situation in which authentication can be obtained (SA43).

Next, the control unit 51 determines whether or not the counting process of the elapsed time t has been started (SA32). In a case where the counting process of the elapsed time t has not been started, the control unit 51 starts the counting process of the elapsed time t (SA33).

As a result of the determination of SA32, in a case where the counting process of the elapsed time t has been started or after the process of SA33 is ended, the control unit 51 determines whether or not the elapsed time t exceeds the predetermined period t1 (SA51). The process of SA52 and subsequent steps are similar to those according to the embodiment described above.

According to this modified example, in addition to the acquisition of effects similar to those of the embodiment, after the process (SA21) of receiving a seed, the process for starting the limiting process is performed. Accordingly, the process for starting the limiting process can be performed in a sequence different from that according to the embodiment.

### Modified Example 5 of First Embodiment

A modified example 5 of the first embodiment will be described. In this modified example, the trigger for starting counting of SA33 described above is not the transmission (SA31) of a response signal but the occurrence of an authentication process restart event. In this modified example, “the occurrence of an authentication process restart event”, for example, includes the following cases.

(1) In the determination of SA41, a case where the elapsed time T after the transition to the authentication completion waiting state exceeds a predetermined response time T2
(2) In the determination of SA42, a case where an authentication completion notification is not legitimate (the authentication has not been cleared) through an authentication process
(3) In the determination of SA53, a case where an authentication restart factor such as communication blocking occurs

For example, in a case where any one of the authentication process restart factors described above occurs, the control unit 51 determines whether or not the counting process of an elapsed time t has been started (SA32). In a case where the counting process of the elapsed time t has not been started, the control unit 51 starts the counting process of the elapsed time t (SA33). For example, the elapsed time t according to the modified example is an elapsed time after the occurrence of the authentication process restart event.

As a result of the determination of SA32, in a case where the counting process of the elapsed time t has been started or after the process of SA33 is ended, the control unit 51 causes the process to proceed to SA3.

According to this modified example, in addition to the acquisition of effects similar to those according the embodiment, the trigger for starting counting of SA33 described above is the occurrence of an authentication process restart event, and accordingly the trigger for starting counting can be performed in a sequence different from that according to the embodiment.

### Modified Example 6 of First Embodiment

A modified example 6 of the first embodiment will be described. In this modified example, in a case where the authentication process restart event described above occurs, the control state may be transitioned to the waiting state (ST0) instead of the transition to the authentication start state (ST1). As a fail-safe process of such a case, even in a case where “presence of an operation” is determined in SA1, the control state may not be controlled to be transitioned to the authentication start state (ST1).

According to this modified example, in addition to the acquisition of effects similar to those according to the embodiment, in a case where the authentication process restart event described above occurs, the process can be restarted from the waiting state (ST0), and the process can be performed in a sequence different from that of the embodiment.

### Second Embodiment

Next, a second embodiment will be described. In the first embodiment, a case of wired communication using the bus 2 as a communication line has been described. Instead of this, in this embodiment, a case of radio communication will be described. Different points from the embodiment described above will be focused in the description.

The communication system 1 illustrated in FIG. 1, for example, is mounted in a vehicle and forms a network NW having an area in which radio communication can be performed inside the vehicle. For example, the communication system is IEEE 802.11, Bluetooth (registered trademark), or the like.

ECUs included in the communication system 1 include an ECU 10-1 that has at least a radio communication interface 10D and enables radio communication. The ECU 10-1 enabling radio communication may be connected to a common bus 2 together with the other ECUs 10.

A terminal apparatus 60 is a mobile terminal such as a smartphone. The terminal apparatus 60 includes computer and realizes a radio communication function for communicating with the ECU 10-1 by causing e computer to execute a program such as application software, or OS.

In addition, the terminal apparatus 60 is assumed to be able to perform radio communication with the ECU 20 similar to the ECU 10-1 instead of the ECU 10-1. The ECU 20, similar to the first embodiment, disguises an authentication process by executing a malicious program or the like. The terminal apparatus 60 detects a case where a malicious program h like is executed in the ECU 20, and a seed is transmitted using an illegitimate communication protocol.

Regarding this, the terminal apparatus 60 may be configured to perform predetermined fail-safe process for a seed transmitted using an illegitimate communication protocol by using the technique illustrated in the first embodiment described above.

In addition, the terminal apparatus 60 may perform a predetermined fail-safe process by combining processes described below.

For example, the terminal apparatus 60 adjusts the threshold (the predetermined number k1 of times) of the detection number k of times described above on the basis of a reception signal intensity in communication with the ECU 10 or the like.

In the radio communication, when the reception signal intensity decreases, a probability that a packet cannot be normally received according to the influence of interferences, multiple paths, noises, and the like increases. In other words, when the reception signal intensity decreases, a probability that retransmissionis necessary increases.

Thus, in a case where the reception signal intensity of a detected signal is weaker than a predetermined value, the terminal apparatus 60 according to this embodiment adjusts the value of the predetermined number k1 of times described above to a value larger than that of a case where the amount of communication is weaker than a predetermined value.

According to the embodiment described above, in addition to the acquisition of effects similar to those according to the first embodiment, the control unit 11 changes the value of the number k1 of times of setting the determination condition in accordance with a communication state. For example, in a case where the reception signal intensity RSI of radio communication is weaker than the threshold TH, the control unit 11 sets the number k1 of times described above to a value k2 larger than that of a case where the reception signal intensity RST is stronger than the threshold TH, whereby the reliability of authentication through communication can be further improved.

According to at least one embodiment described above, the external apparatus 50 obtains authentication from the ECU 10 or the like (authentication apparatus) on the basis of a KEY2 generated on the basis of a received seed.

The external apparatus 50 includes the control unit that performs a limiting process limiting authentication performed with the ECU 10 or the like in a case where the number k of times authentication performed with the ECU 10 or the like is performed exceeds a predetermined number k1 of times within a predetermined period beginning with from a period after the transmission of a response code, whereby the reliability of authentication through communication can be further improved.

While the forms for performing the present invention have been described using the embodiments, the present invention is not limited to such embodiments, and various modifications and substitutions may be applied within a range not departing from the concept of the present invention.

For example, technologies represented in the embodiments described above may be appropriately combined.

What is claimed is:

1. An authentication target apparatus that obtains authentication from an authentication apparatus on the basis of a response code generated on the basis of a received challenge code, the authentication target apparatus comprising:
a control unit configured to perform a limiting process limiting the authentication performed with the authentication apparatus when a number of times the authentication is performed with the authentication apparatus exceeds a predetermined number of times within a predetermined period beginning with a period after transmission of a response code.

2. The authentication target apparatus according to claim 1, wherein the control unit is configured to perform the limiting process when a number of times a request signal requesting the authentication apparatus to transmit the challenge code is transmitted exceeds the predetermined number of times within the predetermined period.

3. The authentication target apparatus according to claim 1, wherein the control unit is configured to perform the limiting process when a number of times the challenge code is received exceeds the predetermined number of times within the predetermined period.

4. The authentication target apparatus according to claim 1, wherein the control unit is configured to perform the limiting process when a number of times the response code is transmitted exceeds the predetermined number of times within the predetermined period.

5. The authentication target apparatus according to claim 1, wherein the control unit is configured to perform the limiting process when a number of times an authentication process restart event occurs exceeds the predetermined number of times within the predetermined period.

6. The authentication target apparatus according to claim 5, wherein the control unit sets reception of a signal indicating reception of a signal from an unauthenticated apparatus from the authentication apparatus as the authentication process restart event.

7. The authentication target apparatus according to claim 5, wherein the control unit sets no reception of a signal from the authentication apparatus over a predetermined period as the authentication process restart event.

8. The authentication target apparatus according to claim 5, wherein the control unit sets reception of a signal representing blocking of communication with the authentication apparatus from the authentication apparatus as the authentication process restart event.

9. The authentication target apparatus according to claim 1, wherein the control unit is configured to perform a predetermined fail-safe process together with the limiting process.

10. The authentication target apparatus according to claim 1, wherein the predetermined period begins with a period after completion of the authentication performed with the authentication apparatus.

11. The authentication target apparatus according to claim 1, wherein the limiting process is a process of blocking communication with the authentication apparatus.

12. The authentication target apparatus according to claim 5, wherein the limiting process is a process of not performing the authentication even when the authentication process restart event occurs.

13. The authentication target apparatus according to claim 5, wherein the limiting process is a process of not transmitting a request code requesting the challenge code even when the authentication process restart event occurs.

14. The authentication target apparatus according to claim 1, wherein the limiting process is a process of not transmitting the response code even when the challenge code is received from the authentication apparatus.

15. The authentication target apparatus according to claim 1, wherein limiting process is a process of transmitting a code different from the response code corresponding to the challenge code received from the authentication apparatus as the response code.

16. A communication system comprising:
the authentication target apparatus according to claim 1; and
an authentication apparatus configured to authenticate the authentication target apparatus.

17. A communication method for obtaining authentication from an authentication apparatus on the basis of a response code generated on the basis of a received challenge code, the communication method comprising:
limiting the authentication performed with the authentication apparatus when a number of times the authentication is performed with the authentication apparatus exceeds a predetermined number of times within a predetermined period beginning with a period after transmission of the response code.

18. A program causing a computer of an authentication target apparatus obtaining authentication from an authentication apparatus on the basis of a response code generated on the basis of a received challenge code to execute:
limiting the authentication performed with the authentication apparatus when a number of times the authentication is performed with the authentication apparatus exceeds a predetermined number of times within a predetermined period beginning with a period after transmission of the response code.
